(19) United States
(12) Patent Application Publication
(10) Pub. No.: US 2018/0156245 A1
(43) Pub. Date: Jun. 7, 2018

(54) Rotary Drive with Functional Module Arrangement

(71) Applicant: FESTO AG & Co. KG, Esslingen (DE)

(72) Inventors: Uwe Modinger, Wernau (DE); Mathias Schneider, Stuttgart (DE); Karl Messerschmidt, Esslingen (DE); Andreas Feiler, Schwabisch Gmund (DE); Timo Doring, Ostfildern (DE)

(21) Appl. No.: 15/736,008

(22) PCT Filed: Jun. 15, 2015
(86) PCT No.: PCT/EP2015/063324

§ 371 Date: Dec. 13, 2017

(51) Int. Cl. F15B 15/06; F15B 15/20; F16K 31/163; F15B 15/14

(52) U.S. Cl. CPC F15B 15/065; F15B 15/149; F16K 31/1635; F15B 15/202

(57) ABSTRACT

A fluid-actuated rotary drive with a housing in the form of a tubular body, which has a piston space extending in an axial direction of the housing, in which is movably guided a drive piston assembly for driving a rotatably mounted output shaft, wherein the housing has at one axial end an end face, which is open towards the piston space, with at least one mounting section suitable for the attachment of a housing cover, and with a function module assembly which includes an electronic assembly for monitoring, control and/or regulation of the rotary drive and/or a control valve assembly for actuation of the rotary drive, wherein the function module assembly is placed on the end face and secured by means of at least one mounting section.

The invention relates to a fluid-actuated rotary drive with a housing in the form of a tubular body, which has a piston space extending in an axial direction of the housing, in which is movably guided a drive piston assembly for driving a rotatably mounted output shaft, wherein the housing has at one axial end an end face, which is open towards the piston space, with at least one mounting section suitable for the attachment of a housing cover, and with a function module assembly which includes an electronic assembly for monitoring, control and/or regulation of the rotary drive and/or a control valve assembly for actuation of the rotary drive.

A rotary drive of this kind is generally mounted on a valve fitting. The valve fitting is also referred to below as a process valve, and the combination of valve fitting and rotary drive as a process valve assembly. As a part of this process valve assembly, the rotary drive is used to actuate a valve member, which is in a process fluid, of the valve fitting, in order to influence, control and/or stop a fluid flow. The output shaft of the rotary drive is connected mechanically to a spindle of the valve fitting. The spindle in turn is mechanically coupled to the valve member of the valve fitting, so that the valve member is actuated through actuation of the spindle. The valve member of the valve fitting is for example in the form of a damper, butterfly valve, cone valve, ball valve or ball cock.

The output shaft is driven, as mentioned above, by the drive piston assembly guided movably in the piston space. Expediently, the drive piston assembly divides the piston space into at least two chambers. At least one of the chambers of the piston space may be supplied with a pressurised fluid, so as to effect a movement of the drive piston assembly. The admission of the pressurised fluid may be controlled by a control valve assembly.

The actuation of the drive piston assembly is undertaken in particular through pneumatic control valves which are connected to the rotary drive via the so-called “Namur interface according to VDI/VDE 3845”, a standardised pneumatic interface for the direct attachment of pneumatic control valves.

Known from U.S. Pat. No. 6,135,147 is a rotary drive with a monitoring assembly attached to the top of the rotary drive housing and used to indicate a valve member position. The monitoring assembly is arranged along the upwards-extending output shaft of the rotary drive.

Known from DE 601 12 780 T2 is a rotary drive with a housing in the form of a tubular body, with a functional part attached to the side of the housing or on the lateral surface of the housing. The functional part includes signal transmission means for the feeding or transmission of control signals to a pneumatic control valve.

It is a problem of the invention to provide a rotary drive with a function module assembly in an especially practical and compact form.

The problem is solved for a fluid-actuated rotary drive of the type described above by the features of claim 1.

In the fluid-actuated rotary drive according to the invention, the function module assembly is placed on the end face at the axial end of the housing and secured by means of at least one mounting section.

According to the invention, the function module assembly is therefore placed on the end face which, as mentioned earlier, is located at one axial end of the housing which is in the form of a tubular body. Through the placement of the function module assembly at this end face, the housing of the rotary drive is extended in the axial direction. Consequently, as compared with the prior art, this results in a practical and compact design, in which the installation space of the rotary drive is enlarged mainly in the axial direction.

Preferably, the rotary drive is suitable for mounting on a valve fitting. Generally, the axial direction of the housing corresponds to the alignment of the piping to which the valve fitting which may be actuated by the rotary drive is connected. Therefore an enlargement of the installation space in the axial direction of the housing is less critical than the enlargement of overall height or overall width of a rotary drive known from the prior art. If, for example, several pipe strings are arranged one above the other or adjacent to one another, and if the installation space for the rotary drive upwards or to the side is correspondingly restricted, then the extension of the installation space in the axial direction according to the invention nevertheless permits the use of a rotary drive with a function module assembly.

According to the invention, moreover, the function module assembly is fixed by means of a mounting section, which actually serves for the attachment of a housing cover to the end face. This gives the advantage that no additional mounting sections need to be provided specially for attachment of the function module assembly, so that a simple and cost-effective design is obtained.

Expediently, the function module assembly is placed directly on the end face of the housing. The starting point for the rotary drive according to the invention is, for example, a rotary drive of the type referred to above, in which the housing cover is removed so that the end face of the axial end of the housing is exposed. The function module assembly is then attached directly to the end face and secured with the aid of the at least one mounting section.

The at least one mounting section is provided on the end face open towards the piston space—i.e. at an end face which has an opening towards the piston space i.e. into which the piston space opens out. The end face is formed in particular by the cross-section of the housing in the form of a tubular body i.e. by the end face of the housing wall surrounding the piston space.

The at least one mounting section is preferably a mounting hole. Expediently, two or more mounting sections or mounting holes are provided.

The function module assembly includes, as mentioned above, an electronic assembly for the monitoring, control and/or regulation of the rotary drive, and/or a control valve assembly for actuation of the rotary drive. Preferably, the electronic assembly is used for decentralised control of the rotary drive.

The function module assembly is in particular in the form of a tubular body. Expediently, the function module assembly and/or the housing is so designed that the piston space has a pressure-tight seal when the function module assembly is attached to the housing.

Preferably, the drive piston assembly includes a first and a second driving piston, mounted in the piston space coaxially to one another in the axial direction of the housing and dividing the piston space into at least two chambers. Expediently, the two chambers may be supplied with different pressures so as to effect a movement of the drive piston.

Advantageous embodiments of the invention are the subject of the dependent claims.

In one variant of the invention, it is provided that the piston space has a piston space section which extends into the function module assembly.

The function module assembly therefore has a hollow space which, when the function module assembly is attached to the housing, forms a part—namely the aforementioned piston space section—of the piston space. The piston space is thus extended in the axial direction of the housing and in its own axial direction respectively.

In a further variant of the invention, it is provided that the function module assembly has a partition wall which closes the piston space preferably with sealing.

The function module assembly therefore assumes the function of the housing cover in closing the piston space. The function module assembly may therefore be placed on the end face of the housing in place of the housing cover, without impairing the sealing of the piston space.

In a further variant of the invention, it is provided that the function module assembly has a module compartment in which the electronic assembly and/or the control valve assembly is provided, and the partition wall separates the piston space section from the module compartment, while preferably, in the axial direction of the housing, the piston space section and the module compartment are arranged coaxially and/or one behind the other.

The separation of the module compartment from the piston space avoids fluids present in the piston space penetrating the module compartment, where they might come into contact with sensitive equipment such as an electronic assembly.

Preferably, the partition wall is provided with an opening at which a fluidic outlet of the control valve assembly is connected, so that the assigned chamber of the piston space may be supplied with pressurised fluid, without the pressurised fluid thereby penetrating into the module compartment.

In a further variant of the invention, it is provided that the cross-section of the function module assembly corresponds substantially to the cross-section of the housing at its axial end.

The cross-section of the housing is maintained by the function module assembly. By this measure, it is ensured that the overall height and/or overall width of the rotary drive are not enlarged despite attachment of the function module assembly.

Here, the cross-section which is normal or perpendicular to the axial direction of the housing is designated as the cross-section of the function module assembly and the cross-section of the housing respectively.

Due to the maintenance according to the invention of the cross-section of the housing in the axial direction and the use of the mounting sections already provided, the additional benefit of a design optimised for cleaning is obtained, in which the number of hard-to-clean projections and recesses of the rotary drive body is minimised.

In a further variant of the invention, the fluid-actuated rotary drive includes a housing cover, which is attached to an end face of the function module assembly facing away from the housing.

The function module assembly is thus located between the housing cover and the end face of the housing. Preferably, the function module assembly is braced between the housing cover and the end face of the housing. As an alternative to this, the mounting of the housing cover on the function module assembly is independent of the mounting of the function module assembly on the housing, so that the housing cover may be removed from the function module assembly without impairing the connection between the function module assembly and the housing. This is of particular advantage when the function module assembly and the housing form a pressure-tight unit.

The end face of the housing cover facing the function module assembly has substantially the same geometry as that of the end face of the function module assembly facing the housing, so that the housing cover and the function module assembly may be attached to the end face of the housing, interchangeable with one another.

As a result, the function module assembly is inserted between the housing of the rotary drive and the housing cover using the already existing mounting sections and retaining the cross-section geometry of the drive housing.

The housing cover is preferably used to seal the aforementioned module compartment of the function module assembly. This is especially advantageous if the module compartment is open towards the end face of the function module assembly facing away from the housing.

In a further variant of the invention, it is provided that the housing cover is fixed by at least one mounting means, preferably engaging in the at least one mounting section.

Using the mounting means, the housing cover may be fixed in place at a mounting section, such as one or more mounting holes, provided on the function module assembly.

As an alternative to this, the housing cover attached to the function module assembly may also be fixed to the at least one mounting section of the housing and therefore be fixed in place by the same at least one mounting section also used to fix the function module assembly.

Preferably two or more mounting means are provided. The one or more mounting means are expediently in the form of screws or threaded rods with assigned nuts.

In a further variant of the invention, it is provided that the function module assembly has at least one mounting hole, through which the at least one mounting means is guided or in which the at least one mounting means is fixed.

Preferably, the at least one mounting hole passes through the function module assembly in the axial direction of the housing. The at least one mounting means is thus guided by means of the at least one mounting hole through the function module assembly to the at least one mounting section.

Preferably, two or more mounting holes are provided. In particular, the number of mounting holes corresponds to the number of mounting sections and/or mounting means.

In a further variant of the invention, it is provided that the housing cover has at least one mounting hole, through which the at least one mounting means is guided.

Preferably, the at least one mounting means is guided through the mounting hole and is fixed in the at least one mounting hole of the function module assembly.

As an alternative to this, the one mounting means is guided through the at least one mounting hole of the housing cover and through the at least one mounting hole of the function module assembly to the at least one mounting section. Thus, housing cover and function module assembly are fixed by the same mounting means to the housing of the rotary drive. In this way, an efficient and cost-effective design is obtained.

Preferably, the housing cover includes two or more mounting holes. In particular, the number of mounting holes of the housing cover corresponds to the number of mounting sections and/or mounting means and/or mounting holes of the function module assembly.

In a further variant of the invention, it is provided that the at least one mounting section has at least one mounting hole, in particular to accommodate the at least one mounting means, preferably in the form of a screw.

Preferably, the at least one mounting hole has an inside thread. Expediently, two or more mounting holes are provided.

Preferably, one or more screws, which are screwed into the at least one mounting hole, are provided on the end face of the function module assembly which faces the end face of the housing.

In a further variant of the invention, it is provided that the rotary drive is single-acting and has at least one restoring spring mounted in the piston space, preferably in the piston space section.

In the case of a single-acting fluid-actuated rotary drive, the output shaft is moved in a first direction of rotation through a fluidic actuation of the drive piston assembly. For movement of the output shaft in a second direction of rotation opposite to the first direction of rotation, at least one restoring spring acting on the drive piston assembly is required. During fluidic actuation of the drive piston assembly and movement of the output shaft in the first direction of rotation, this spring is compressed and then, on removal of the fluidic actuation, effects a movement of the output shaft in the second direction.

The at least one restoring spring is provided preferably in the piston space section, which extends into the function module assembly. For this purpose, at least one accommodation section is provided in the piston space section. Preferably, the at least one accommodation section is provided on the aforementioned partition wall. The at least one accommodation section is e.g. in the form of a recess.

In a further variant of the invention, it is provided that, at the end face of the housing, at least one housing passage, through which at least one electrical and/or fluidic connecting line is guided into the function module assembly, opens out and/or at least one housing-side operating passage leading into a chamber of the piston space opens out.

By way of example, the end face of the housing has an opening to a housing-side operating passage which leads into the wall of the housing, which is in the form of a tubular body, to a specific chamber of the piston space, in order to supply the latter with pressurised fluid by means of a control valve located in the function module assembly.

As an alternative or in addition to this, a housing passage for an electrical and/or fluidic connecting line may be provided in the housing wall. The electrical connecting line may provide e.g. a power supply and/or communication link between the electronic assembly in the function module assembly and a sensor array and/or a power supply connection in the housing. The fluidic connecting line may be used to supply a chamber of the piston space with a pressurised fluid passed through the control valve assembly.

The electrical and/or fluidic connections between the housing of the rotary drive and the function module assembly are guided in particular within the body formed by the housing and the function module assembly.

In this manner, it is avoided that these lines are arranged outside the housing or the function module assembly, where the probability of disturbance is generally higher.

Moreover, due to the guidance of the lines within the body formed by the housing and the function module assembly, the need to provide external interfaces for these lines is avoided.

In a further variant of the invention, it is provided that the function module assembly has on the end face, which faces the housing, at least one module channel flush in the axial direction with the at least one housing passage and through which the at least one electrical and/or fluidic connecting line is guided, and/or has at least one module-side operating passage flush in the axial direction with the at least one housing-side operating passage.

The at least one electrical and/or fluidic connecting line is guided directly from the housing into the function module assembly, preferably into the module compartment. There is therefore no need to provide an electrical and/or fluidic interface between the housing and the function module assembly.

The minimisation of electrical and fluidic interfaces avoids faults and malfunctions which might possibly occur at the respective interface connections. This applies in particular in areas of extreme use, involving for example extreme temperatures or extreme environmental conditions.

In a further variant of the invention it is provided that the function module assembly has one or more function modules.

In particular, function modules for different functions are employed. For example, the function module assembly has a fluidic function module which includes e.g. the control valve assembly, and/or an electronic function module, which includes e.g. the electronic assembly.

In a further variant of the invention, it is provided that the function modules are lined up one behind the other in the axial direction of the housing.

The function modules are preferably mounted in a manner already described above, e.g. arranged and braced between housing and housing cover.

In this way, further function modules may be attached without the need to provide further mounting sections on the housing for this purpose.

According to the invention, a process valve assembly is further provided, comprising the fluid-actuated rotary drive described above and a valve fitting with a spindle, a valve member and two piping connections arranged coaxially along a direction of piping, wherein the fluid-actuated rotary drive is mounted on the valve fitting, the output shaft of the valve fitting is coupled mechanically to the spindle of the valve fitting, and the direction of piping runs parallel to the axial direction of the housing.

Exemplary embodiments of the invention are shown in the drawing, in which

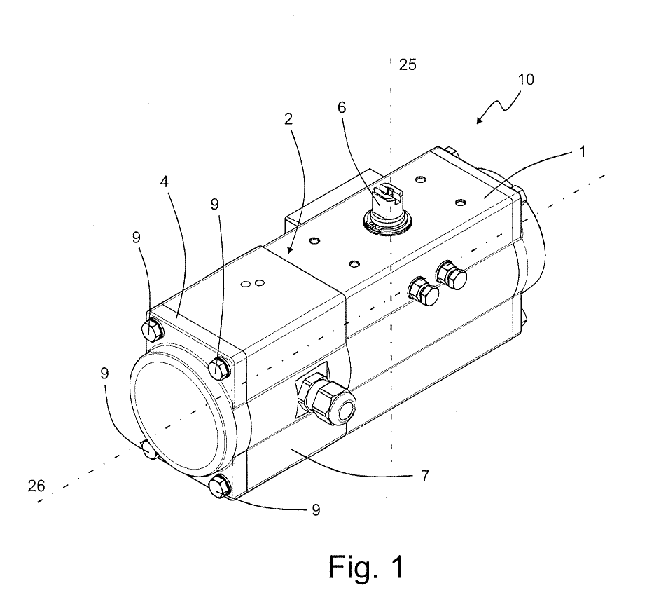

FIG. 1 shows a perspective view of a rotary drive according to a first embodiment

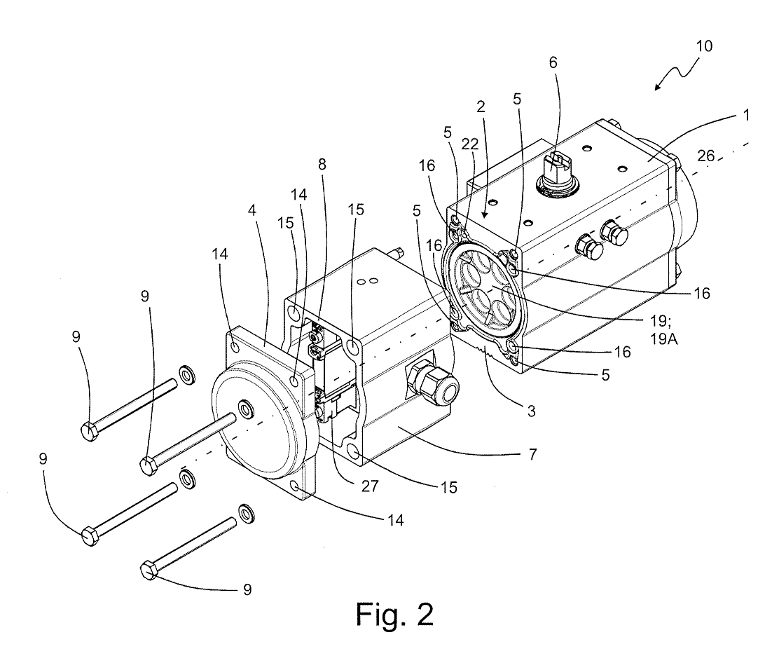

FIG. 2 an exploded view of the rotary drive according to the first embodiment

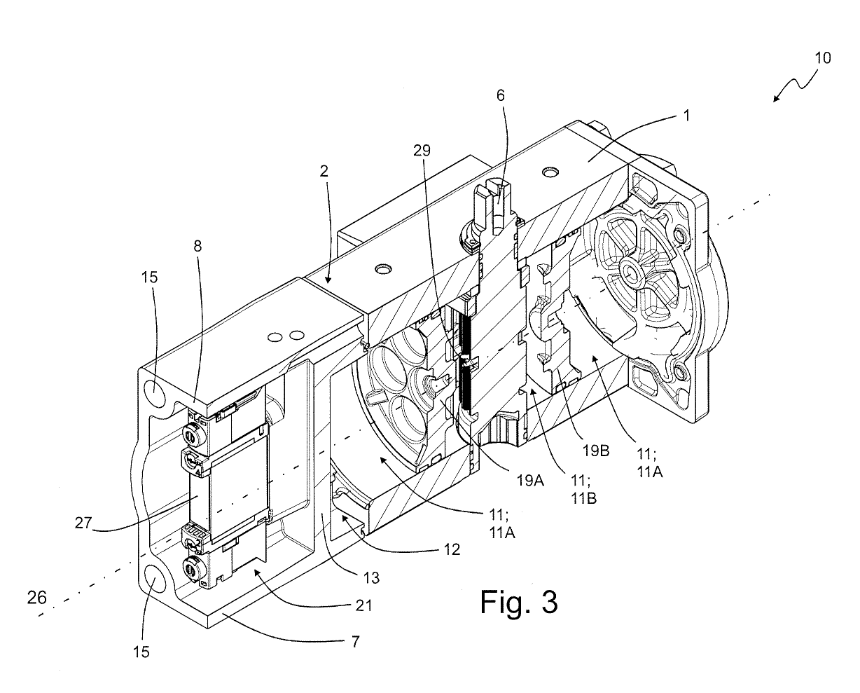

FIG. 3 a perspective sectional view of the rotary drive according to the first embodiment

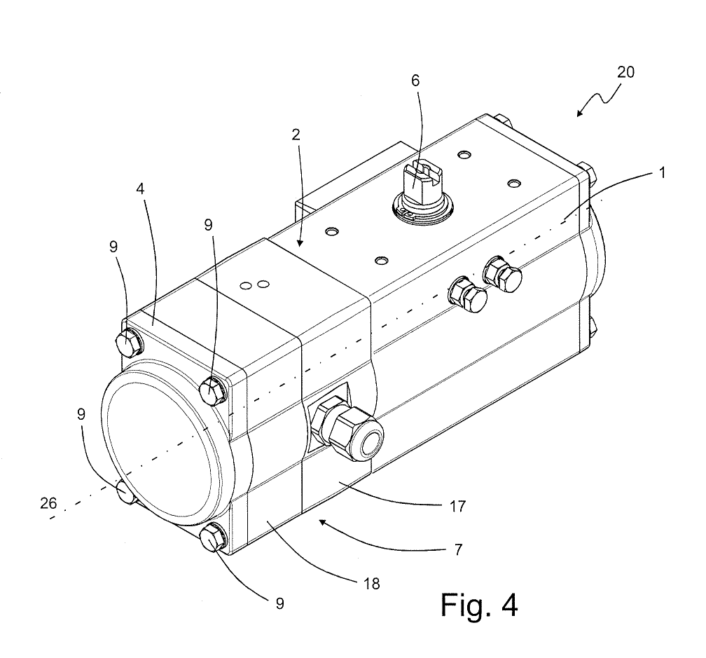

FIG. 4 a perspective view of a rotary drive according to a second embodiment

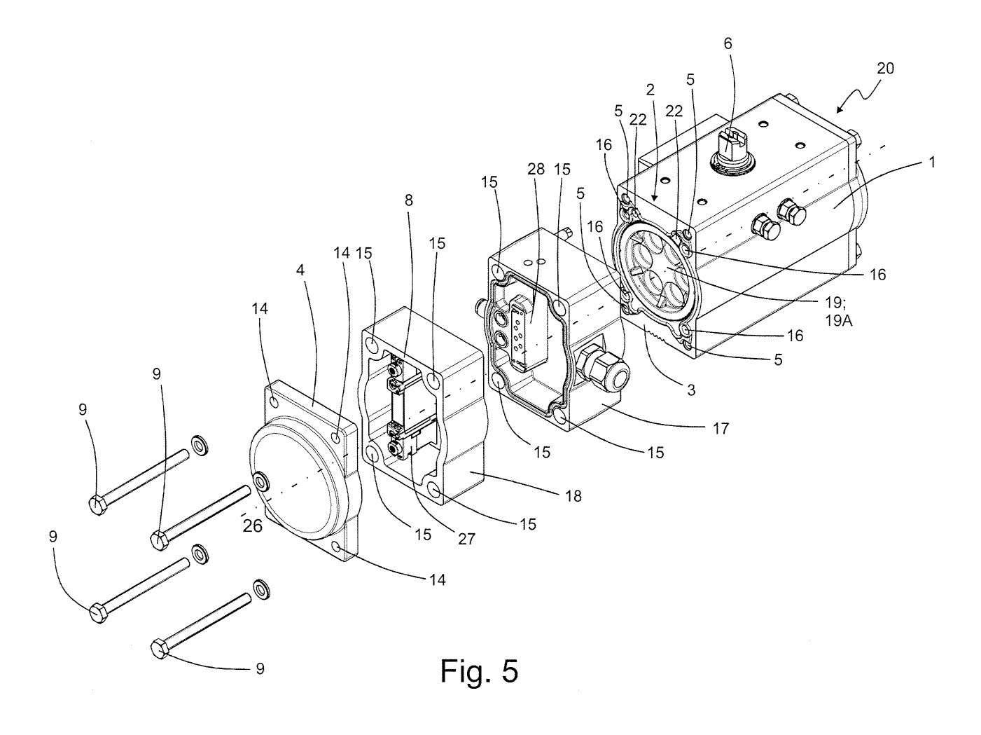

FIG. 5 an exploded view of the rotary drive according to the second embodiment

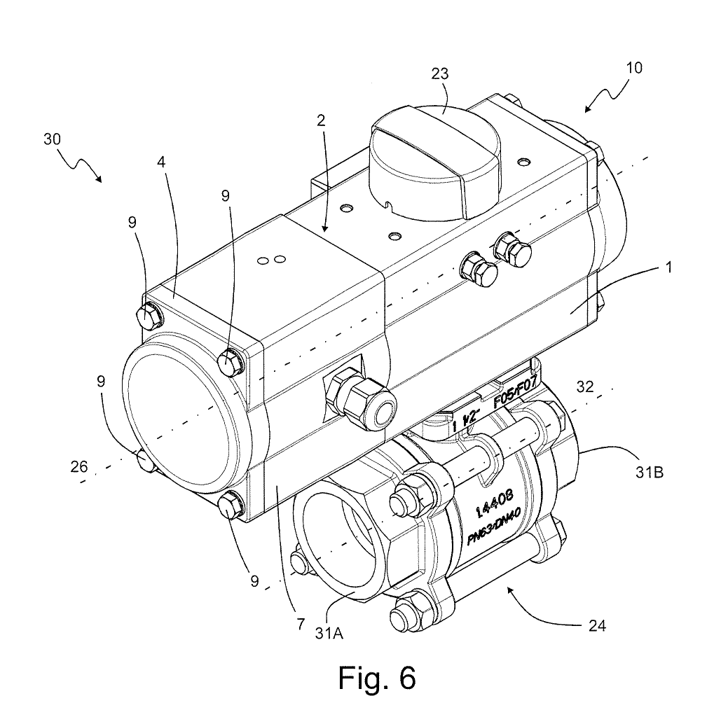

FIG. 6 a perspective view of a process valve assembly according to to a third embodiment

In the following description of the Figures, the same designations are used for functionally identical components of the depicted embodiments, wherein a repeated description of functionally identical components is omitted.

FIG. 1 shows a perspective view of a rotary drive 10 according to a first embodiment.

The rotary drive 10 of the first embodiment is suitable to be mounted on a valve fitting, in order to actuate a valve member of the valve fitting, thereby influencing or controlling a fluid flow.

The rotary drive 10 has a housing 1, tubular or in the form of a tubular body, which extends in an axial direction 26. An output shaft 6 runs through the housing 1, perpendicular to the axial direction 26. The output shaft 6 is mounted rotatably around an imaginary rotation axis 25 and is driven by a drive piston assembly 19, not depicted. The output shaft 6 is suitable for actuating the valve member of the aforementioned valve fitting.

The housing 1 has a piston space 11 extending in the axial direction 26, in which the drive piston assembly 19 is movably guided to drive the rotatably mounted output shaft 6.

The housing 1 also has at an axial end 2—i.e. at an end of the housing 1 in the axial direction 26—an end face 3 open towards the piston space 11, with at least one mounting section 5 suitable for the attachment of a housing cover 4.

At the end face 3 a function module assembly 7 is placed on the housing 1 and fixed by means of at least one mounting section 5. The function module assembly 7 includes an electronic assembly for monitoring, control and/or regulation of the rotary drive and/or a control valve assembly 27 for actuation of the rotary drive.

The function module assembly 7 has substantially the same cross-section as the housing 1 at the axial end 2 and therefore represents effectively an extension of the housing 1 in the axial direction 26. Preferably, the function module assembly 7 has the same cross-section as the housing 1 at the axial end 2. At this point, cross-section means in particular the outer course of the respective body periphery perpendicular or normal to the axial direction 26. In this context, connections at the function module assembly and/or the housing may be ignored. Preferably, the function module assembly 7 comprises a tubular body with the same cross-section as the housing 1 in the form of a tubular body, and is attached flush with the latter.

Placed on the axial end of the function module assembly 7 facing away from the housing 1 is a housing cover 4. The housing cover 4 similarly has substantially, preferably precisely, the same cross-section as the housing 1 at the axial end 2. The housing cover 4 is fastened to the function module assembly 7 and/or the housing 1 with the aid of mounting means 9, here in the form of screws.

The mounting means 9 are guided through mounting holes 14 in the housing cover 4 and the function module assembly 7 to mounting sections of the housing 1, where they are fixed in place.

According to the invention, therefore, the function module assembly 7 is attached to an axial end 2 of the housing 1 with the aid of already existing mounting sections suitable for the mounting of the housing cover 4. In this way, as already explained above, the benefit of a practical and compact design is obtained.

In addition, the cross-section of the function module assembly 7 facing the rotary drive 10 has a the same geometry as the housing cover 4 and assumes its task—for example the preferably pressure-tight sealing of the piston space.

FIG. 2 shows an exploded view of the rotary drive 10 according to the first embodiment. FIG. 2 shows in particular the end face 3 at the axial end 2 of the housing 1, and the mounting sections 5 provided there in the form of mounting holes. The figure also shows the first driving piston 19A located in the piston space 11. In the depicted view, the first driving piston 19A is located at the axial end 2 of the housing 1, for which reason the part of the piston space 11 belonging to the housing 1 is not visible.

The mounting sections 5, together with the housing passages 16, are distributed around the opening to the piston space 11 on the end face 3. Also provided on the end face 3 is a housing-side operating passage 22. The housing passages 16 are used to guide electrical and/or fluidic connecting lines from the function module assembly 7 into the housing 1. The housing-side operating passage 22 is provided to supply a chamber of the piston space 11 with compressed air, by means of a control valve assembly located in the function module assembly 7, in order to effect a movement of the drive piston assembly 19. At this point it should be mentioned that not all passages or passage openings shown in FIG. 2 need be occupied or used.

The function module assembly 7 has on the end face, which faces the housing 1, module channels arranged to correspond with the housing passages 16. This means that the module channels are so arranged that they and the housing passages 16 are aligned flush with one another in the axial direction when the function module assembly 7 is attached to the housing 1, so that a passage is formed between the function module assembly 7 and the housing 1. The function module assembly 7 also has at least one module-side operating passage, which is arranged so as to correspond to the housing-side operating passage 22. As an alternative or in addition to this configuration, the module-side operating passage may also be arranged to correspond to one of the housing passages 16.

Due to this configuration of the rotary drive 10, the electrical and/or pneumatic connections between the housing 1 and the function module assembly 7 may be guided within the body formed by the function module assembly 7 and the housing 1.

Also shown in FIG. 2 are the mounting holes 14 of the housing cover 4 and the mounting holes 15 of the function module assembly 7. The mounting holes 14 and 15 are arranged so as to be flush with and correspond to one another, so that the housing cover may be fastened to the function module assembly 7 by the mounting means 9. The function module assembly 7 in turn is fastened to the housing 1 by at least one separate mounting means or by a screw, which is provided on the end face which faces the end face 3 of the housing 1.

This separate fastening of the housing cover 4 to the function module assembly 7 and of the function module assembly 7 to the housing 1 provides the advantage that the housing cover 4 may be removed from the function module assembly 7 while maintaining a pressure-tight seal of the piston space 11. Consequently, the function module assembly 7 is accessible from the front, while at the same time the pressure-tightness of the piston space 11 can be maintained.

However, as an alternative to the configuration described above, each of the housing cover 4 and the function module assembly 7 may also be fastened to the same mounting section 5 of the housing 1 by the same mounting means 9.

FIG. 3 shows a perspective sectional view of the rotary drive 10 according to the first embodiment. The rotary drive 10 is shown here without the housing cover 4.

In the present view, the first driving piston 19A is in a position shifted somewhat backwards, i.e. away from the function module assembly 7. This makes it possible to see, in the front at the axial end 2 of the housing 1, a part of the piston space 11 belonging to the housing 1. The piston space section 12 belonging to the function module assembly 7 connects at the part of the piston space 11 belonging to the housing 1. The piston space 11 therefore also extends, on account of the piston space section 12, into the function module assembly 7.

Shown in FIG. 3, in addition to the first driving piston 19A, is a second driving piston 19B arranged coaxially to the first driving piston. The two driving pistons 19A and 19B include gear racks, not shown here, each aligned in the axial direction and in meshing engagement with a driven pinion 29 fitted to the output shaft 6, in order to convert a linear movement of the driving pistons 19A and 19B into a rotary movement of the output shaft 6. In particular, the gear racks are here arranged on opposite sides of the output shaft 6, so that linear movements of the driving pistons 19A and 19B in opposite directions are converted into respective rotary movements of the output shaft 6. Thus the output shaft 6 rotates in a first direction of rotation when the driving pistons 19A and 19B run towards one another, and in a second direction of rotation when the driving pistons 19A and 19B move away from one another. Alternatively to the arrangement of gear racks and driven pinion 29, a tumbler yoke (scotch yoke) may also be used to convert the linear movement of the drive piston assembly 19 into a rotary movement of the output shaft 6.

The driving pistons 19A and 19B divide the piston space 11 into two chambers 11A and 11B. The first chamber 11A is divided into two and is located between the first driving piston 19A and the partition wall 13, also between the second driving piston 19B and the rear closure of the piston space 11. The second chamber 11B is positioned between the first driving piston 19A and the second driving piston 19B.

The depicted rotary drive 10 functions according to the double-acting principle; i.e. that the chambers 11A and 11B can be supplied with different pressures so that, by means of pressurisation, actuation of the output shaft 6 in both directions of rotation is possible. For pressurisation of the chambers, in the example shown the control valve assembly 27 is used. This is connected to the two chambers via suitable module-side and housing-side operating passages.

The function module assembly 7 includes a module compartment 21 which, as shown by way of example in FIG. 3, may include the control valve assembly 27. The control valve assembly 27 includes for example a 5/2- or 5/3-way valve with two pilot valves. The module compartment 21 is separated from the piston space section 12 by the partition wall 13. The function module assembly 7 thus forms the termination of the piston space 11.

As an alternative to the double-acting rotary drive 10 shown in FIG. 3, the rotary drive according to the invention may also be designed as single-acting. In this case, only the second chamber 11B can be supplied with pressure, while the first chamber 11A is vented. Consequently, by means of pressurisation, it is possible to actuate the output shaft 6 only in a first direction of rotation. In order to allow actuation of the output shaft 6 in a second direction of rotation as well, restoring springs are inserted into the piston space 11 and the piston space section 12 respectively of the single-acting rotary drive, and are supported at one end on the first driving piston 19A and at the other end on the partition wall 13. To accommodate the restoring springs, suitable accommodation sections, such as e.g. cylindrical recesses, may be provided in the partition wall 13 and in the first driving piston 19A. Alternatively, the restoring springs may also be inserted between the second driving piston 19B and the rear end of the piston space 11, with provision of suitable accommodation sections, such as e.g. cylindrical recesses, in the second driving piston 19B and the rear end.

FIG. 4 shows a perspective view of a rotary drive 20 according to a second embodiment. The second embodiment differs from the embodiment described above in that, for the second embodiment, the function module assembly 7 includes two function modules 17 and 18, lined up one behind the other.

The housing cover 4 and the function module 18 are here fastened to the function module 17 preferably by means of the same mounting means 9. The function module 17 is then fastened by means of at least one separate mounting means, which is provided on the end face 3 of the function module 17 facing the end face of the housing 1, to the mounting section or sections 5 of the housing 1. Because of this separate mounting, the housing cover 4 and the function module 18 may be removed without releasing the fastening between the function module 17 and the housing 1. This is of particular advantage when the function module 17 and the housing 1 form a unit which gives pressure-tight sealing of the piston space 11.

As an alternative to this, the housing cover 4 and the two function modules 17 and 18 may also be fastened to the housing 1 of the rotary drive 20 by the same mounting means 9. In this case it is possible in an advantageous manner for several function modules to be fastened to the housing 1 using the same mounting means 9 and the same mounting sections 5.

FIG. 5 shows an exploded view of the rotary drive 20 depicted in FIG. 4. As is evident in FIG. 5, the function modules 17 and 18 have substantially the same cross-section as the housing 1 at is axial end 2. By this means, the installation space of the rotary drive 10 is enlarged only in its axial direction 26 when the function modules 17 and 18 are attached.

In addition, the mounting holes 15 of the function modules 17 and 18 are arranged to correspond to one another so that, when the function modules 17 and 18 are placed together, they lie flush to or on top of one another in the axial direction. This means that the same mounting means 9 may be used for fastening the housing cover 4 and the function module 18 to the function module 17.

FIG. 6 shows a perspective view of a process valve assembly 30 of a third embodiment. The process valve assembly 30 includes the rotary drive 10 described above. As an alternative to this, the process valve assembly 30 includes the rotary drive 20 described above. The rotary drive 10 is mounted on a valve fitting 24 and, together with the latter, forms the process valve assembly 30. The rotary drive 10 serves in this connection to actuate by means of the output shaft 6 a valve member such as a damper, butterfly valve, cone valve, ball valve or ball cock of the valve fitting 24. For this purpose, the output shaft 6 of the rotary drive 10 is mechanically connected to a spindle of the valve fitting 24. The spindle in turn is mechanically coupled to the valve member of the valve fitting 24, so that the valve member is actuated through actuation of the spindle.

The rotary drive 10 shown in FIG. 6 also has an indicator device 23 which serves to detect and make visible the position of the valve member via the position of the output shaft 6.

As shown in FIG. 6, the installation space of the rotary drive 10 is extended in the axial direction 26 by the attachment according to the invention of the function module assembly 7 at the axial end 2 of the housing 1. The axial direction 26 corresponds to the direction of piping 32 of the valve fitting 24, as may be seen in the alignment of the ports 31A, 31B of the valve fitting 24. Normally, going from the rotary drive 10 in the direction of piping 32—i.e. directly above the piping—there is sufficient space that an extension of installation space in this direction generally presents no problem. The process valve assembly 30 according to the invention therefore has an especially space-saving design.

In operation, the process valve assembly 30 is supplied with compressed air from a line connected to an external pressure connection of the rotary drive 10. The compressed air is fed through the control valve assembly 27, which is for example in the form of a 5/3-way valve, in particular bistable. The outlets of the control valve assembly 27 are connected via corresponding operating passages with the chambers 11A and 11B of the piston space 11. The outlets of the control valve assembly 27 are switched according to a control command to a pressure or venting state so as to hold the driving pistons 19A and 19B in their current position or to move them towards or away from one another, or to hold them in a defined position. The control command is output to the control valve assembly 27 for example by an electronic assembly located in the function module assembly 7. Through the movement of the driving pistons 19A and 19B the output shaft 6 is actuated, which in turn actuates the spindle of the valve fitting 24 and finally the valve member of the valve fitting 24.

1. A fluid-actuated rotary drive with a housing in the form of a tubular body, which has a piston space extending in an axial direction of the housing, in which is movably guided a drive piston assembly for driving a rotatably mounted output shaft, wherein the housing has at one axial end an end face, which is open towards the piston space, with at least one mounting section suitable for the attachment of a housing cover, and with a function module assembly which includes an electronic assembly for monitoring, control and/or regulation of the rotary drive and/or a control valve assembly for actuation of the rotary drive, and wherein the function module assembly is placed on the end face and secured by means of the at least one mounting section.

2. The fluid-actuated rotary drive according to claim 1, wherein the piston space has a piston space section which extends into the function module assembly.

3. The fluid-actuated rotary drive according to claim 1, wherein the function module assembly has a partition wall which closes the piston space preferably with sealing.

4. The fluid-actuated rotary drive according to claim 3, wherein the function module assembly has a module compartment in which the electronic assembly and/or the control valve assembly is provided, and the partition wall separates the piston space section from the module compartment, while the piston space section and the module compartment are arranged coaxially and/or one behind the other in the axial direction of the housing.

5. The fluid-actuated rotary drive according to claim 1, wherein the cross-section of the function module assembly corresponds substantially to the cross-section of the housing at its axial end.

6. The fluid-actuated rotary drive according to claim 1, further comprising a housing cover, which is placed on an end face of the function module assembly facing away from the housing.

7. The fluid-actuated rotary drive according to claim 6, wherein the housing cover is fixed by at least one mounting means engaging in the at least one mounting section.

8. The fluid-actuated rotary drive according to claim 7, wherein the function module assembly has at least one mounting hole, through which the at least one mounting means is guided or in which the at least one mounting means is fixed.

9. The fluid-actuated rotary drive according to claim 7, wherein the housing cover has at least one mounting hole, through which the at least one mounting means is guided.

10. The fluid-actuated rotary drive according to claim 7, wherein the at least one mounting section comprises at least one mounting hole, to accommodate the at least one mounting means.

11. The fluid-actuated rotary drive according to claim 1, wherein the rotary drive is single-acting and has at least one restoring spring mounted in the piston space.

12. The fluid-actuated rotary drive according to claim 1, wherein, at the end face of the housing, at least one housing passage, through which at least one electrical and/or fluidic connecting line is guided into the function module assembly, opens out and/or at least one housing-side operating passage leading into a chamber of the piston space opens out.

13. The fluid-actuated rotary drive according to claim 12, wherein the function module assembly has on the end face which faces the housing at least one module channel, which is flush in the axial direction with the at least one housing passage and through which the at least one electrical and/or fluidic connecting line is guided, and/or has at least one module-side operating passage flush in the axial direction with the at least one housing-side operating passage.

14. The fluid-actuated rotary drive according to claim 1, wherein the function module assembly has one or more function modules lined up one behind the other in the axial direction of the housing.

15. A process valve assembly comprising a fluid-actuated rotary drive according to claim 1 and a valve fitting with a spindle, a valve member and two piping connections arranged coaxially along a direction of piping, wherein the fluid-actuated rotary drive is mounted on the valve fitting, the output shaft of the fluid-actuated rotary drive is coupled mechanically via the spindle to the valve member of the valve fitting, and the direction of piping runs parallel to the axial direction of the housing.
